(19) United States
(12) Patent Application Publication
(10) Pub. No.: US 2026/0269363 A1
(43) Pub. Date: Sep. 10, 2026

(54) BATTERY PACK COOLANT REDIRECTING SUPPORT ASSEMBLY HAVING SURFACE AREA AUGMENTING FEATURES

(71) Applicant: Ford Global Technologies, LLC, Dearborn, MI (US)

(72) Inventors: Jie Deng, Novi, MI (US); Liam E. West, Ferndale, MI (US); Mihir Devendra Upadhye, Livonia, MI (US); Brad Alan VanDerWege, Plymouth, MI (US)

(21) Appl. No.: 19/217,705

(22) Filed: May 23, 2025

Related U.S. Application Data
(60) Provisional application No. 63/766,623, filed on Mar. 4, 2025.

(51) Int. Cl. H01M 10/6556; H01M 10/613

(52) U.S. Cl. CPC H01M 10/6556; H01M 10/613; H01M 2220/20

(57) ABSTRACT

A battery pack assembly includes an enclosure assembly having an interior area; first and second cell stacks disposed along a cell stack axis within the interior area; and a support assembly that is axially between the first and second cell stacks within the interior area. The support assembly includes a first plate spaced axially from a second plate to provide a coolant channel between the first plate and the second plate. The coolant channel is configured to communicate a coolant that has been communicated over the first cell stack in a direction transverse to the cell stack axis before the coolant is communicated over the second cell stack. At least one of the first plate or the second plate includes a plurality of protrusions that project into the coolant channel.

### CROSS REFERENCE TO RELATED APPLICATIONS

This disclosure claims priority to U.S. Provisional Application No. 63/766,623, which was filed on 4 Mar. 2025, and is incorporated herein by reference in its entirety.

### TECHNICAL FIELD

This disclosure details exemplary support assemblies used within an enclosure assembly of a traction battery pack and, more particularly, to support assemblies that redirect coolant flow within the enclosure assembly.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a battery pack assembly, including: an enclosure assembly having an interior area; first and second cell stacks disposed along a cell stack axis within the interior area; and a support assembly that is axially between the first and second cell stacks within the interior area, the support assembly including a first plate spaced axially from a second plate to provide a coolant channel between the first plate and the second plate, the coolant channel configured to communicate a coolant that has been communicated over the first cell stack in a direction transverse to the cell stack axis before the coolant is communicated over the second cell stack, wherein at least one of the first plate or the second plate includes a plurality of protrusions that project into the coolant channel.

In some aspects, the techniques described herein relate to a battery pack assembly, further including a coolant inlet to the interior area on a first side of the enclosure assembly, and a coolant outlet on a different, second side of the enclosure assembly, wherein the first and second cell stacks and the support assembly are disposed axially between the coolant inlet on the first side and the coolant outlet on the second side.

In some aspects, the techniques described herein relate to a battery pack assembly, wherein the first cell stack is upstream from the second cell stack relative to a general direction of flow through the interior area.

In some aspects, the techniques described herein relate to a battery pack assembly, wherein the first cell stack is closer to the coolant inlet than the coolant outlet, wherein the second cell stack is closer to the coolant outlet than the coolant inlet.

In some aspects, the techniques described herein relate to a battery pack assembly, wherein the coolant inlet extends through a first horizontally facing side of the enclosure assembly, and the coolant outlet extends through an opposite, second horizontally facing side of the enclosure assembly.

In some aspects, the techniques described herein relate to a battery pack assembly, wherein the support assembly redirects the coolant in a direction transverse to a general direction of coolant flow through the interior area.

In some aspects, the techniques described herein relate to a battery pack assembly, wherein first cell stack is an upstream cell stack and the second cell stack is a downstream cell stack.

In some aspects, the techniques described herein relate to a battery pack assembly, wherein the support assembly is spaced from both the first and second cell stacks.

In some aspects, the techniques described herein relate to a battery pack assembly, wherein the plurality of protrusions includes a plurality of first ribs of the first plate and a plurality of second ribs of the second plate, the plurality of first ribs at least partially received between the plurality of second ribs.

In some aspects, the techniques described herein relate to a battery pack assembly, wherein the plurality of first ribs and the plurality of second ribs each extend longitudinally in a direction that is transverse to the cell stack axis.

In some aspects, the techniques described herein relate to a battery pack assembly, wherein the plurality of first ribs each extend vertically from a top side of the first plate to a bottom side of the first plate, wherein the plurality of second ribs each extend vertically from a top side of the second plate to a bottom side of the second plate.

In some aspects, the techniques described herein relate to a battery pack assembly, wherein the plurality of first ribs and the plurality of second ribs extend longitudinally in a horizontal direction.

In some aspects, the techniques described herein relate to a battery pack assembly, wherein the first plate includes a first plate upper lip and a first plate lower lip that each project toward the first cell stack, wherein the second plate includes a second plate upper lip and a second plate lower lip that each project toward the second cell stack.

In some aspects, the techniques described herein relate to a battery pack assembly, wherein the first plate upper lip and the first plate lower lip project from a first axial side of the first plate, wherein the plurality of first ribs project from an opposite second axial side of the first plate.

In some aspects, the techniques described herein relate to a battery pack assembly, wherein the plurality of protrusions includes a plurality of first dimples of the first plate and a plurality of second dimples of the second plate, the plurality of first dimples at least partially received between the plurality of second dimples.

In some aspects, the techniques described herein relate to a battery pack assembly, wherein the first plate and the second plate are each attached directly to the enclosure assembly.

In some aspects, the techniques described herein relate to a battery pack assembly, wherein the first plate includes a plurality of support assembly inlet apertures, and the second plate includes a plurality of support assembly outlet apertures.

In some aspects, the techniques described herein relate to a battery pack assembly, wherein the plurality of support assembly inlet apertures are a plurality of first holes adjacent a vertically upper edge of the first plate, the first plate establishing an entire circumferential perimeter of the plurality of first holes, wherein the plurality of support assembly outlet apertures are a plurality of second holes adjacent a vertically lower edge of the second plate, the second plate establishing an entire circumferential perimeter of the plurality of second holes.

In some aspects, the techniques described herein relate to a battery pack assembly, including: an enclosure assembly holding a dielectric immersion coolant within an interior area; at least one first cell stack and at least one second cell stack disposed within the interior area along an axis of the enclosure assembly; a coolant inlet on a first axial end of the enclosure assembly, and a coolant outlet on a second axial end of the enclosure assembly, at least one first cell stack closer to the coolant inlet than the coolant outlet, the at least one second cell stack closer to the coolant outlet than the coolant inlet; and a support assembly disposed along the axis between the least one first cell stack and the least one second cell stack within the interior area, the support assembly having a first plate having portions spaced from a second plate, the support assembly configured to communicate a flow of immersion coolant between the first plate and the second plate in a direction transverse to the axis, the support assembly including a plurality of surface area augmenting features that increase an surface area of the support assembly interfacing with the flow of immersion coolant.

In some aspects, the techniques described herein relate to a battery pack assembly, wherein the plurality of surface area augmenting features are projections from the first plate, projections from the second plate, or both.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective view of a battery array from the battery pack of FIG. 1 with an enclosure cover expanded away to show an interior area.

FIG. 3 illustrates a section view taken at line 3-3 in FIG. 2 with the enclosure cover installed and showing a path that coolant can flow through the interior area.

FIG. 4 illustrates a perspective view of a support assembly from the battery pack of FIG. 2.

FIG. 5 illustrates a close-up view of an area of FIG. 4.

FIG. 6 illustrates an expanded view of the support assembly of FIG. 4.

FIG. 7 illustrates a support assembly that could be used with the battery array of FIG. 2 according to another exemplary aspect of the present disclosure.

FIG. 8 illustrates a support assembly that could be used with the battery array of FIG. 2 according to yet another exemplary aspect of the present disclosure.

FIG. 9 illustrates a close-up view of an area of FIG. 8.

FIG. 10 illustrates a support assembly that could be used with the battery array of FIG. 2 according to still another exemplary aspect of the present disclosure.’

FIG. 11 illustrates a perspective view of a first plate from the support assembly of FIG.

FIG. 12 illustrates a perspective view of a second plate from the support assembly of FIG.

FIG. 13 illustrates an end view of the support assembly of FIG. 10

FIG. 14 illustrates a section view taken at line 14-14 in FIG. 13.

### DETAILED DESCRIPTION

An immersion thermal management system can be used to manage thermal energy in a traction battery pack. In such a traction battery pack, at least some components of the traction battery pack are immersed in a liquid coolant within an enclosure assembly. The immersed components can include at least one cell stack.

This disclosure is directed toward a support assembly used within the enclosure assembly. The support assembly can be utilized to redirect the liquid coolant such that liquid coolant carrying vent byproducts from one cell stack does not flow directly across another cell stack. The support assembly can include protrusions that can increase a surface area of the support assembly that interfaces with the liquid coolant, which can facilitate transfer of thermal energy from the coolant to the support assembly.

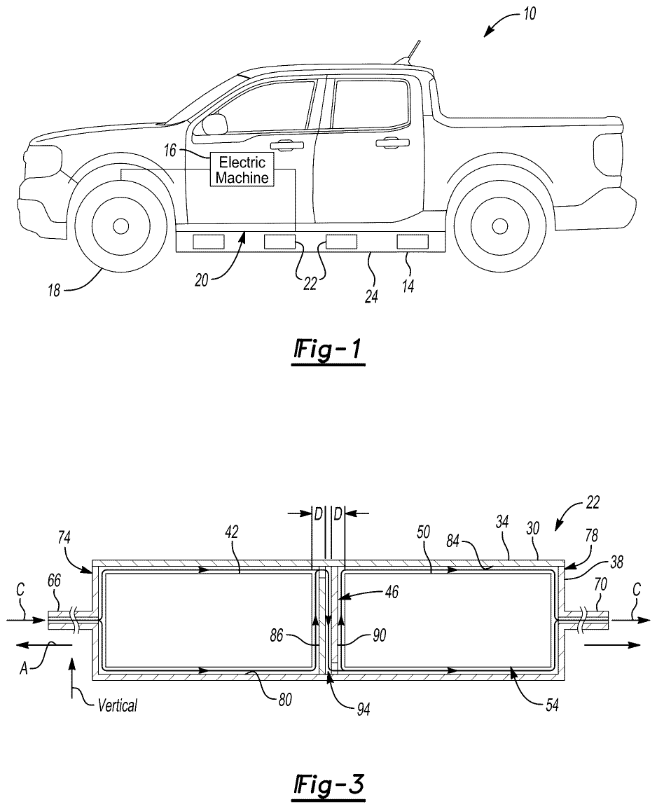

With reference to FIG. 1, an electrified vehicle 10 includes a traction battery pack 14, an electric machine 16, and wheels 18. The traction battery pack 14 powers the electric machine 16, which can convert electrical power to mechanical power to drive the wheels 18. The traction battery pack 14 can be a relatively high-voltage battery.

The traction battery pack 14 is, in the exemplary embodiment, secured to an underbody 20 of the electrified vehicle 10. The traction battery pack 14 could be located elsewhere on the electrified vehicle 10 in other examples. In the exemplary embodiment, the traction battery pack 14 includes one or more battery arrays 22 housed within a pack enclosure 24.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

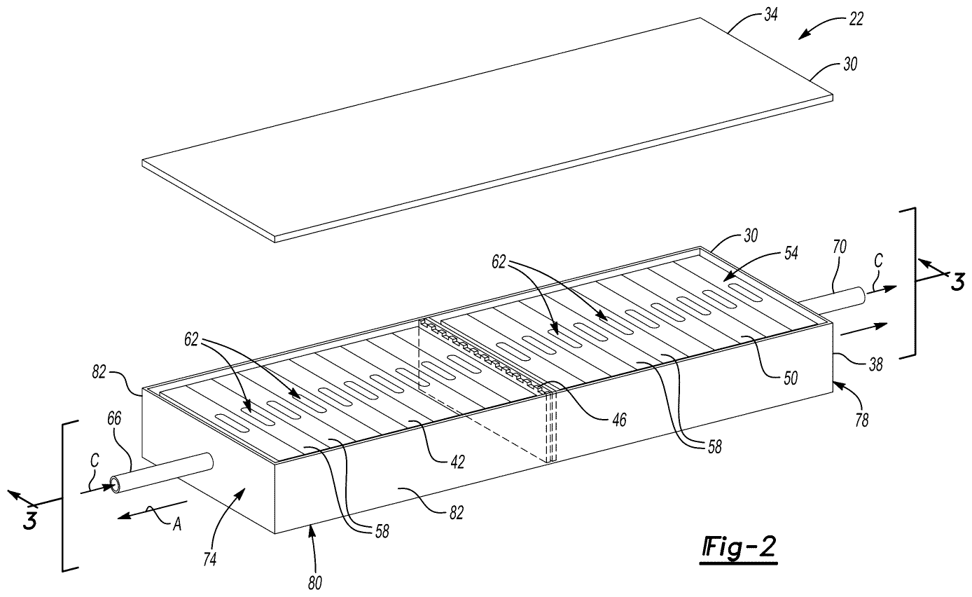

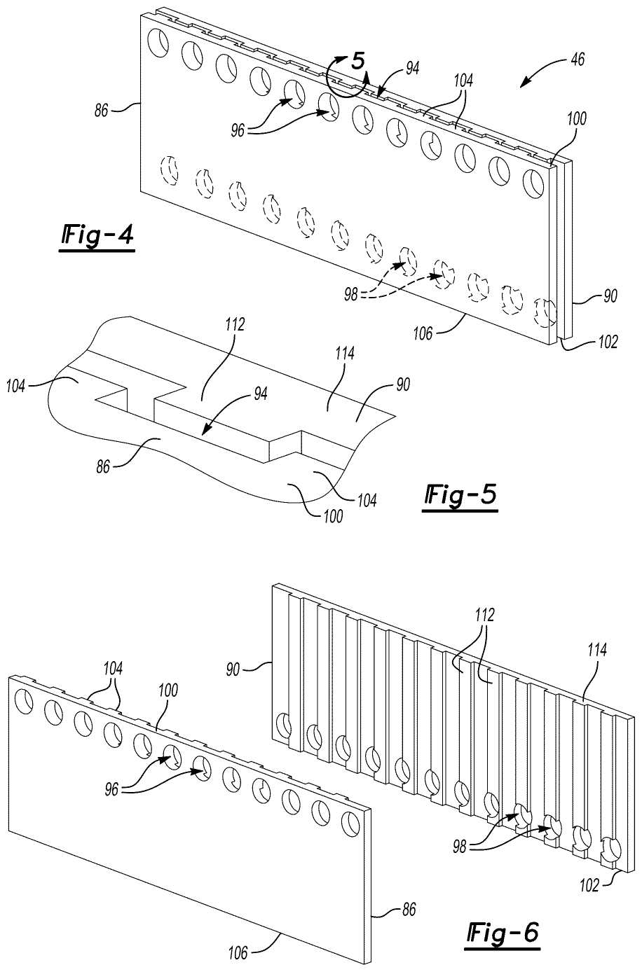

FIGS. 2-5 illustrate additional detail of one of the arrays 22 from the battery pack 14. In this example, the array 22 includes an array enclosure assembly 30 having enclosure structures —here a cover 34 and a tray 38. The cover 34, in this example, is vertically above the tray 38. In other examples, however, the cover 34 could be arranged below, or to a side of the tray 38. The array 22 and its array enclosure assembly 30 are contained within the pack enclosure 24. The cover 34 and the tray 38 can be cast from aluminum, for example.

Various terms such as “vertical,” “above,” “below,” “top,” and “bottom” are used relative to the arrangement of the components of the battery array 22 in the various drawings and should not otherwise be deemed limiting. These terms are with reference to the general orientation of the battery array 22 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a first cell stack 42, a support assembly 46, and a second cell stack 50 are arranged within an interior area 54 of the enclosure assembly 30 along a longitudinal axis A of the enclosure assembly 30. The support assembly 46 is disposed within the interior area 54 between the first cell stack 42 and the second cell stack 50 along the longitudinal axis A. The first cell stack 42 and the second cell stack 50 each includes a plurality of individual battery cells 58 disposed along the axis A.

In the exemplary embodiment, the battery cells 58 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The battery cells 58 of the first cell stack 42 and the battery cells 58 of the second cell stack 50 can each include a vent 62. In this example, the vents 62 are schematically shown in upwardly facing sides of the battery cells 58. The vents 62 could be in any side or edge of the battery cells 58. The vents 62 can be a ruptured area within an edge of a pouch of the respective battery cells 58. No dedicated venting port is required.

The first cell stack 42 and the second cell stack 50 could include any number of battery cells 58. The battery array 22 could be expanded to employ at least one third cell stack within the enclosure assembly 30. Thus, this disclosure is not limited to the exact configuration shown in FIG. 2.

A liquid coolant based thermal management system is used to manage thermal energy levels within the battery array 22. The thermal management system is an immersion thermal management system at least because portions of the battery array 22, here at least the battery cells 58 of the first cell stack 42 and the second cell stack 50, are immersed in a liquid coolant C.

The example thermal management system is configured to route the non-conductive (i.e., dielectric) liquid coolant C through an inlet 66 into the interior area 54 of the enclosure assembly 30. Within the interior area 54 the coolant C can take on heat from the first cell stack 42, the second cell stack 50, and from other components.

The coolant C can then exit the enclosure assembly 30 through an outlet 70. The inlet 66, in this example, extends through a first axial side 74 of the enclosure assembly 30, and the outlet 70 extends through an opposite second axial side 78. In this example, the first axial side 74 and the second axial side 78 are horizontally facing sides of the enclosure assembly 30.

After entering the interior area 54 through the inlet 66, the coolant C flows first over the first cell stack 42 and then over the second cell stack 50 as shown in FIG. 3. The first cell stack 42 can be considered an upstream cell stack relative to the second cell stack 50, which can be considered a downstream cell stack. That is, the first cell stack 42 is closer to the inlet 66 than the outlet 70, and the second cell stack 50 is closer to the outlet 70 than the inlet 66.

The first cell stack 42 and the second cell stack 50 are elevated above a floor 80 of the tray 38, are spaced inward from side walls 82 of the enclosure assembly 30, and from an underside 84 of the cover 34. Coolant C can thus flow beneath the first cell stack 42, along the sides of the first cell stack 42, and over an upper side of the first cell stack 42. Coolant can also flow beneath the second cell stack 50, along the sides of the second cell stack 50, and over an upper side of the second cell stack 50.

The support assembly 46 redirects coolant C that has been communicated over the first cell stack 42. The support assembly 46 can be attached directly to the enclosure assembly 30. In an example, the support assembly 46 is welded to the enclosure assembly 30.

The support assembly 46 helps to strengthen the enclosure assembly 30 and the overall array 22 while permitting flow of the coolant C through the interior area 54 from the inlet 66 to the outlet 70.

In this example, the support assembly 46 includes a first plate 86 having portions spaced from a second plate 90 to provide a coolant channel 94 for the coolant C. In this example, the first plate 86 is spaced a distance from the second plate 90 and does not contact the first plate 86. In other examples, some portions of the first plate 86 are spaced a distance from the second plate 90 to establish the coolant channel 94 while other portions of the first plate 86 contact the second plate 90.

The first plate 86 is spaced a distance D along the axis A from the first cell stack 42. The second plate 90 is similarly spaced a distance D along the axis from the second cell stack 50. The support assembly 46, with the first plate 86 and the second plate 90, form no part of the first cell stack 42 and the second cell stack 50 in the exemplary embodiment, but embodiments are contemplated where the first plate 86 could form part of the first cell stack 42 and where the second plate 90 could form part of the second cell stack 50. The first plate 86 and the second plate 90 can be aluminum.

To permit flow of coolant C through the support assembly 46 and into the coolant channel 94, the first plate 86 of the support assembly 46 includes a plurality of support assembly inlet apertures 96, and the second plate 90 of the support assembly 46 includes a plurality of support assembly outlet apertures 98. The plurality of support assembly inlet apertures 96 and the plurality of support assembly outlet apertures 98 are on opposite vertical sides of the support assembly 46. In particular, the plurality of support assembly inlet apertures 96 are on a vertically upper side of the support assembly 46 adjacent a vertically upper edge 100 of the first plate 86, and the plurality of support assembly outlet apertures 98 are on a vertically lower side of the support assembly 46 adjacent a vertically lower edge 102 of the second plate 90.

In the exemplary embodiment the plurality of support assembly inlet apertures 96 are holes having their entire circumferential perimeter provided by the first plate 86. Similarly, the plurality of support assembly outlet apertures 98 are holes having their entire circumferential perimeter provided by the second plate 90 In another example, the inlet apertures 96, the outlet apertures 98, or both, are slots that open to upper edge 100 of the first plate 86 or lower edge 102 the second plate 90.

Coolant C that has passed over the first cell stack 42 enters the coolant channel 94 through the plurality of support assembly inlet apertures 96. The coolant C then moves vertically downward in a direction transverse to the longitudinal axis A through the coolant channel 94. The coolant C exits the coolant channel 94 through the plurality of support assembly outlet apertures 98.

Using the support assembly 46 to redirect the coolant C increases a distance that coolant C that has passed over the first cell stack 42 must travel prior to reaching the second cell stack 50. Should one or more of the battery cells 58 in the first cell stack 42 be venting and expelling vent byproducts into the coolant C, thermal energy in the mixture of vent byproducts and coolant C can be reduced as the mixture flows through the coolant channel 94. The thermal energy can, for example, within the coolant channel 94, transfer to the first plate 86 or the second plate 90, which is then passed to the cover 34 and the tray 38. The thermal energy of the vent byproducts can also be reduced as the vent byproducts mix with the coolant C along the flow path. Reducing the thermal energy in the mixture of coolant C and vent byproducts prior to the reaching the second cell stack 50 can help stop the thermal event occurring the in the first cell stack 42 from cascading to the second cell stack 50 due to thermal energy within the mixture of coolant and vent byproducts.

To facilitate thermal transfer from the coolant C and the vent byproducts within the coolant channel 94 to the first plate 86, the first plate 86 includes surface area augmenting features, which in this example are a plurality of protrusions 104 that project into the coolant channel 94. The example protrusions 104 are ribs. The protrusions 104 extend longitudinally in a direction that is transverse to the array axis A. The protrusions 104 extend longitudinally from the upper edge 100 of the first plate 86 to an opposite edge 106 of the first plate 86 in this example. That is, the example protrusions 112 extend vertically from a first side of the first plate 86 to an opposite, second side of the first plate 86.

The second plate 90 includes a plurality of protrusions 112-—here again ribs—that project into the coolant channel 94. The protrusions 112 extend longitudinally in a direction that is transverse to the array axis A. The protrusions 112 extend longitudinally from the lower edge 102 of the second plate 90 to an upper edge 114 of the second plate 90. That is, the example protrusions 112 extend vertically from a first side of the second plate 90 to an opposite, second side of the second plate 90.

The protrusions 104 of the first plate 86 are horizontally offset from the protrusions 112 of the second plate 90. When the support assembly 46 is in an installed position, the protrusions 104 of the first plate 86 project between the protrusions 112 of the second plate 90. That is, the protrusions 104 of the first plate 86 are at least partially received between the protrusions 112 of the second plate 90 such that the protrusions 104 of the first plate 86 at least partially axially overlap the protrusions 112 of the second plate 90.

The protrusions 104 of the first plate 86 and the protrusions 112 of the second plate 90 increase surface area of the first plate 86 and the second plate 90 that interface with the coolant C. The protrusions 104 and the protrusions 112 can be considered surface augmenting features as the protrusions 104 and the protrusions 112 result in more surface area of the first plate 86 and more surface area of the second plate 90 in contact with the coolant C, which facilitates a transfer of thermal energy from the coolant C to the support assembly 46.

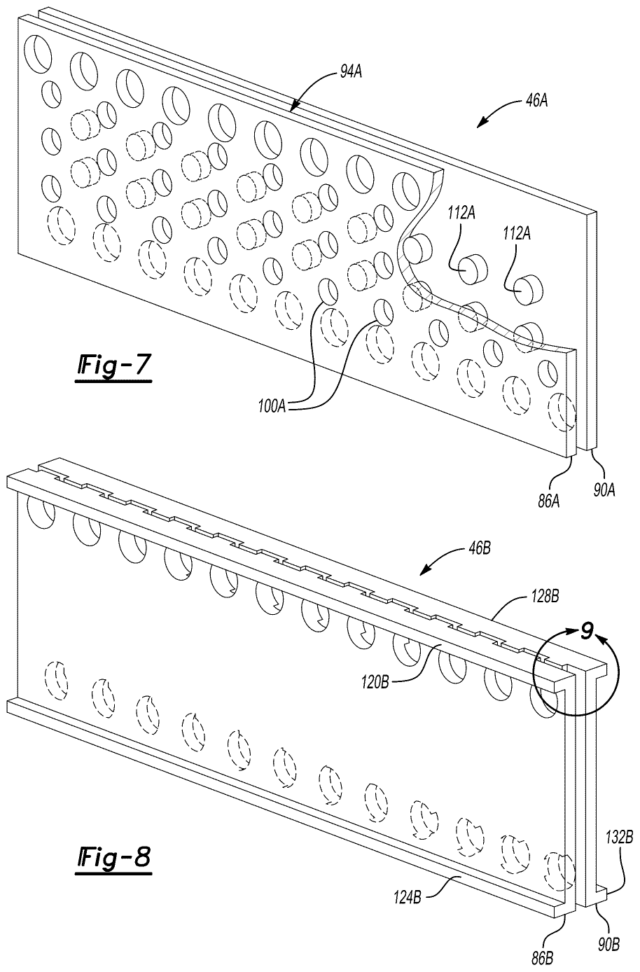

The protrusions 104 and the protrusions 112 are ribs in this example, but other types of protrusions could be used. For example with reference to FIG. 7, a support assembly 46A according to another exemplary aspect of the present disclosure includes a first plate 86A at least partially spaced from a second plate 90A to provide a coolant channel 94A

The first plate 86A has protrusions 100A and a second plate 90A that has protrusions 112A. The protrusions 100A and the protrusions 112A are surface area augmenting features that are dimples. The dimples can be dome shaped and can project into the coolant channel 94A. The dimples have a circular profile but could instead have an oval-shaped profile. The dimples can increase surface area of the first plate 86A and a surface area of the second plate 90A that interfaces with the coolant communicating through the coolant channel 94A. The dimples may also turbulate or mix the flow of the coolant to further facilitate thermal energy transfer from the coolant to the support assembly 46A.

The example protrusions 100A can extend axially between the protrusions 112A and vice versa such that the protrusions 100A and the protrusions 112A at least partially overlap along an axis of the associated enclosure assembly.

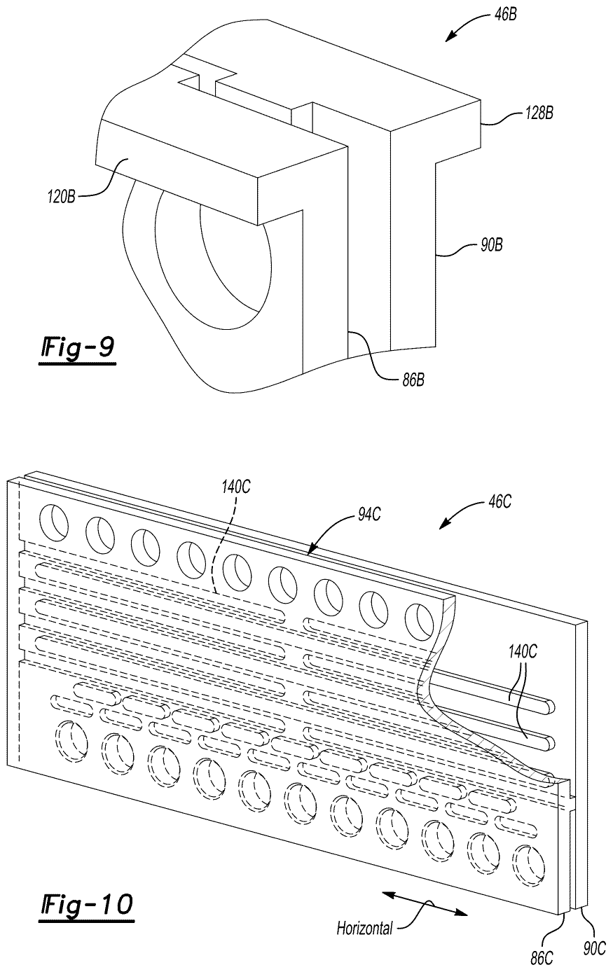

With reference to FIGS. 8 and 9, a support assembly 46B according to another exemplary aspect of the present disclosure includes a first plate 86B and a second plate 90B that include ribs as surface area augmenting features like the support assembly 46 of FIGS. 2-6. The first plate 86B, however, includes an upper lip 120B and a lower lip 124B that each extend axially from a side of the first plate 86B opposite the rib. Similarly, the second plate 90B includes an upper lip 128B and a lower lip 132B that extend axially from a side of the second plate 90B opposite the ribs. The upper lips 120B, 128B and the lower lips 124B, 132B provide the support assembly 46B with more surface area at a vertical top and vertical bottom for attaching the support assembly 46B to an associated enclosure assembly.

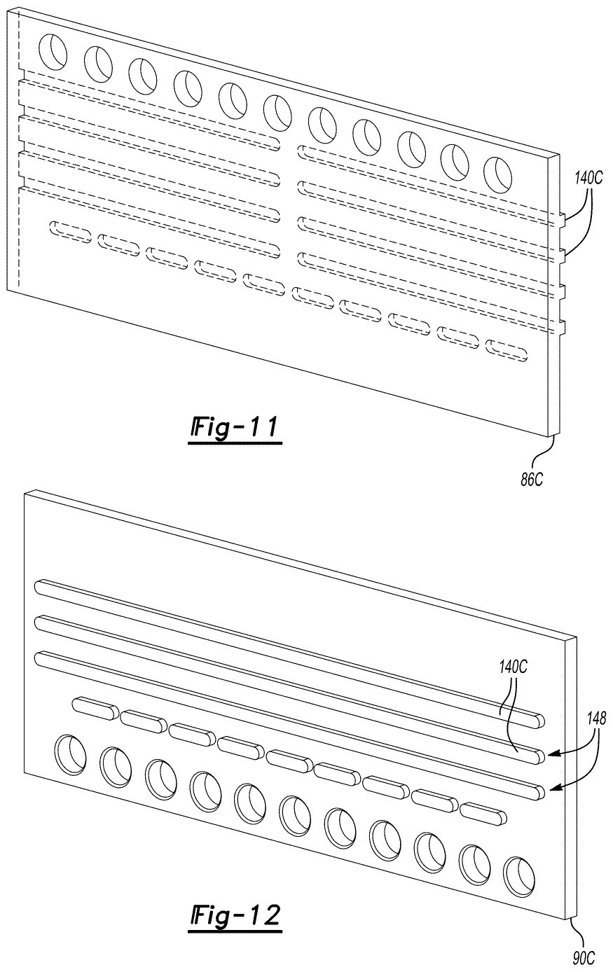

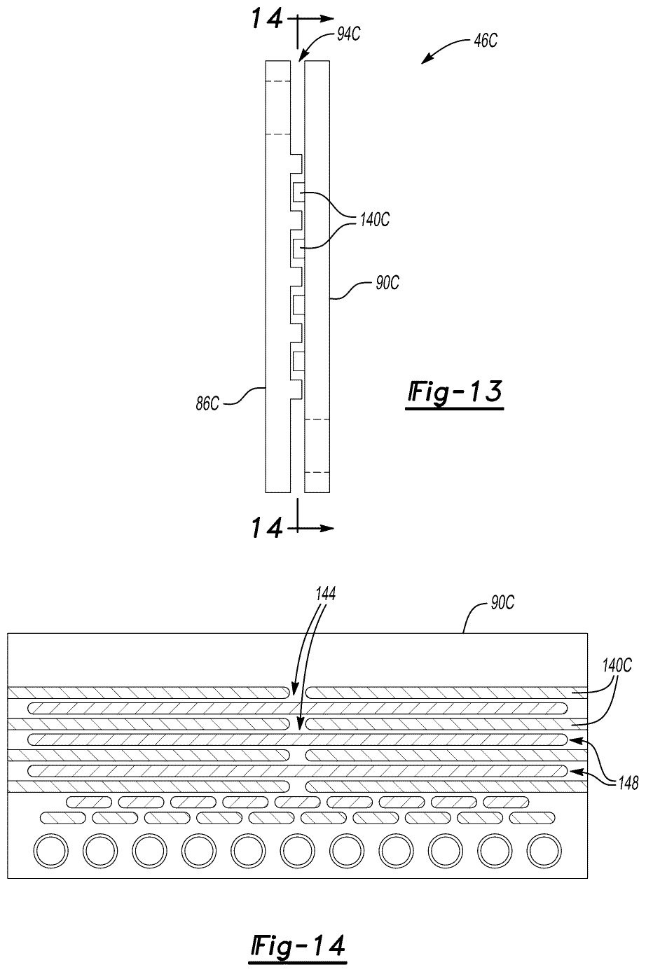

With reference to FIGS. 10-14, a support assembly 46C according to yet another exemplary aspect of the present disclosure includes a first plate 86C and a second plate 90C that each include ribs 140C that help to establish a coolant channel 94C. The ribs 140C are each oriented horizontally, not vertically like the embodiment of FIGS. 2-6.

The ribs 140C of the first plate 86C can span horizontally across the first plate 86C from outboard edge to outboard edge. The ribs 140C of the first plate 86C can include a gap 144 to permit coolant flow vertically downward through the coolant channel 94C.

The ribs 140C of the second plate 90C can stop short of extending entirely across the second plate 90C to provide gaps 148 at the outboard sides to permit coolant flow vertically downward through the coolant channel 94C. The coolant can follow a circuitous path when flowing through the coolant channel 94C of the support assembly 46C.

Features described in connection with any of the embodiments of this disclosure are applicable to all embodiments, unless such features are incompatible. Features of this disclosure include providing a coolant channel within a support assembly and incorporating surface area augmenting features to facilitate thermal energy transfer between the coolant within the channel and the support assembly.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
an enclosure assembly having an interior area;
first and second cell stacks disposed along a cell stack axis within the interior area; and
a support assembly that is axially between the first and second cell stacks within the interior area, the support assembly including a first plate spaced axially from a second plate to provide a coolant channel between the first plate and the second plate, the coolant channel configured to communicate a coolant that has been communicated over the first cell stack in a direction transverse to the cell stack axis before the coolant is communicated over the second cell stack,
wherein at least one of the first plate or the second plate includes a plurality of protrusions that project into the coolant channel.

2. The battery pack assembly of claim 1, further comprising a coolant inlet to the interior area on a first side of the enclosure assembly, and a coolant outlet on a different, second side of the enclosure assembly, wherein the first and second cell stacks and the support assembly are disposed axially between the coolant inlet on the first side and the coolant outlet on the second side.

3. The battery pack assembly of claim 2, wherein the first cell stack is upstream from the second cell stack relative to a general direction of flow through the interior area.

4. The battery pack assembly of claim 2, wherein the first cell stack is closer to the coolant inlet than the coolant outlet, wherein the second cell stack is closer to the coolant outlet than the coolant inlet.

5. The battery pack assembly of claim 2, wherein the coolant inlet extends through a first horizontally facing side of the enclosure assembly, and the coolant outlet extends through an opposite, second horizontally facing side of the enclosure assembly.

6. The battery pack assembly of claim 1, wherein the support assembly redirects the coolant in a direction transverse to a general direction of coolant flow through the interior area.

7. The battery pack assembly of claim 1, wherein first cell stack is an upstream cell stack and the second cell stack is a downstream cell stack.

8. The battery pack assembly of claim 1, wherein the support assembly is spaced from both the first and second cell stacks.

9. The battery pack assembly of claim 1, wherein the plurality of protrusions comprises a plurality of first ribs of the first plate and a plurality of second ribs of the second plate, the plurality of first ribs at least partially received between the plurality of second ribs.

10. The battery pack assembly of claim 9, wherein the plurality of first ribs and the plurality of second ribs each extend longitudinally in a direction that is transverse to the cell stack axis.

11. The battery pack assembly of claim 9, wherein the plurality of first ribs each extend vertically from a top side of the first plate to a bottom side of the first plate, wherein the plurality of second ribs each extend vertically from a top side of the second plate to a bottom side of the second plate.

12. The battery pack assembly of claim 9, wherein the plurality of first ribs and the plurality of second ribs extend longitudinally in a horizontal direction.

13. The battery pack assembly of claim 9, wherein the first plate includes a first plate upper lip and a first plate lower lip that each project toward the first cell stack, wherein the second plate includes a second plate upper lip and a second plate lower lip that each project toward the second cell stack.

14. The battery pack assembly of claim 13, wherein the first plate upper lip and the first plate lower lip project from a first axial side of the first plate, wherein the plurality of first ribs project from an opposite second axial side of the first plate.

15. The battery pack assembly of claim 1, wherein the plurality of protrusions comprises a plurality of first dimples of the first plate and a plurality of second dimples of the second plate, the plurality of first dimples at least partially received between the plurality of second dimples.

16. The battery pack assembly of claim 1, wherein the first plate and the second plate are each attached directly to the enclosure assembly.

17. The battery pack assembly of claim 1, wherein the first plate includes a plurality of support assembly inlet apertures, and the second plate includes a plurality of support assembly outlet apertures.

18. The battery pack assembly of claim 17, wherein the plurality of support assembly inlet apertures are a plurality of first holes adjacent a vertically upper edge of the first plate, the first plate establishing an entire circumferential perimeter of the plurality of first holes, wherein the plurality of support assembly outlet apertures are a plurality of second holes adjacent a vertically lower edge of the second plate, the second plate establishing an entire circumferential perimeter of the plurality of second holes.

19. A battery pack assembly, comprising:
an enclosure assembly holding a dielectric immersion coolant within an interior area;
at least one first cell stack and at least one second cell stack disposed within the interior area along an axis of the enclosure assembly;
a coolant inlet on a first axial end of the enclosure assembly, and a coolant outlet on a second axial end of the enclosure assembly, at least one first cell stack closer to the coolant inlet than the coolant outlet, the at least one second cell stack closer to the coolant outlet than the coolant inlet; and
a support assembly disposed along the axis between the least one first cell stack and the least one second cell stack within the interior area, the support assembly having a first plate having portions spaced from a second plate, the support assembly configured to communicate a flow of immersion coolant between the first plate and the second plate in a direction transverse to the axis, the support assembly including a plurality of surface area augmenting features that increase an surface area of the support assembly interfacing with the flow of immersion coolant.

20. The battery pack assembly of claim 19, wherein the plurality of surface area augmenting features are projections from the first plate, projections from the second plate, or both.
